(19) United States
(12) Patent Application Publication
(10) Pub. No.: US 2010/0226215 A1
(43) Pub. Date: Sep. 9, 2010

(54) DEVICE FOR CORRECTING A TIMEPIECE DISPLAY MECHANISM

(75) Inventors: Olivier Mahler, Boecourt (CH); Salvatore Dettori, Savagnier (CH)

Correspondence Address: GRIFFIN & SZIPL, PC, SUITE PH-1, 2300 NINTH STREET, SOUTH, ARLINGTON, VA, 22204, US

(73) Assignee: OMEGA SA, Bienne (CH)

(21) Appl. No.: 12/663,140

(22) PCT Filed: Jun. 2, 2008
(86) PCT No.: PCT/EP2008/056776

§ 371 Date: May 24, 2010

(30) Foreign Application Priority Data
Jun. 4, 2007 (EP) 07109530.1

(51) Int. Cl. G04B 27/02

(52) U.S. Cl. 368/190

(57) ABSTRACT

The invention relates to a device for correcting a time indication given by a display mechanism for a timepiece of the type comprising a first display member, comprising:
a winding stem arranged to occupy at least one time indication correction position A,
a pinion coupled in rotation to the winding stem,
a correction motion transfer connected kinematically to the pinion when the stem is occupying the correction position A, and
a correction wheel assembly engaging with the display member and operated by the correction motion transfer. According to the invention, the correction motion transfer is formed by a ring having an internal circumference and an external circumference, at least one of which is provided with teeth meshing at least indirectly with said correction wheel assembly.

This is a National Phase Application in the United States of International Patent Application PCT/EP 2008/056776 filed Jun. 2, 2008, which claims priority on European Patent Application No 07109530.1 of Jun. 4, 2007. The entire disclosures of the above patent applications are hereby incorporated by reference.

### FIELD OF THE INVENTION

The present invention relates to the field of horology. More specifically, it concerns a device for correcting a mechanism displaying a time indication, such as a date, day of the week, month etc.

### BACKGROUND OF THE INVENTION

Mechanisms displaying a time indication generally include one or more display members, such as discs or rings, actuated in rotation by a drive mechanism. Corrections devices for such display mechanisms are well known to those skilled in the art. They mainly include a winding stem arranged to occupy at least one time indication correcting position, a pinion that is secured in rotation to the winding stem, an intermediate wheel meshed with the pinion when the stem is in the correcting position and a corrector wheel set which is activated by the intermediate wheel and cooperates with a first display member. The unit is generally mounted on a bottom plate, on the dial side.

When the display mechanism has two display members, the corrector wheel set is slidably mounted between two correcting positions, so that the change from one correcting position to the other occurs by reversing the direction of rotation of the winding stem. Thus, the corrector wheel set is, for example, mounted on a lever actuated by the intermediate wheel. The assembly formed by the intermediate wheel, the lever and the corrector wheel set is located at 3 o'clock, in proximity to the winding stem. It takes up a considerable amount of space, which makes it inconvenient to incorporate if there are other parts in proximity to the winding stem. This is the case, particularly, when chronograph counter arbours pass through the bottom plate in proximity to the winding stem. The space available for the display mechanism corrector device is thus greatly limited.

One solution to this difficulty consists in moving the lever-corrector wheel set unit to another section of the bottom plate, for example, to 9 o'clock, using a series of intermediate wheels, which are mounted to rotate freely about the arbours of the various counters. This solution takes a great deal of space on the bottom plate. It is difficult to implement if the plate is already occupied by a drive mechanism.

The present invention overcomes this drawback, by proposing a device for correcting the time indication of a display mechanism, wherein the lever-corrector wheel set unit is moved to one of the 9 o'clock, 6 o'clock or 12 o'clock sectors of the plate, thereby releasing useful space on the plate.

### SUMMARY OF THE INVENTION

More specifically, the invention concerns a device for correcting a time indication provided by a timepiece display mechanism of the type including a first display member that has:
a winding stem arranged to occupy at least one time indication correcting position,
a pinion mounted on the winding stem and secured in rotation thereto,
an intermediate corrector wheel that is kinematically connected to said pinion when the stem is occupying the correcting position, and
a corrector wheel set that cooperates with the display member and is actuated by the intermediate corrector wheel,
   characterized in that the intermediate corrector wheel is formed of a ring with an inner circumference and an outer circumference, at least one of which has a toothing that meshes, at least indirectly, with the corrector wheel set.

Owing to its ring-shaped geometry, the intermediate corrector wheel frees space inside its inner circumference, which means that parts, for example counter arbours, can be housed therein. Moreover, if the diameter of the intermediate corrector wheel is large compared to the other parts of the correction device, the lever-corrector wheel set unit can be moved away from the immediate vicinity of the winding stem, thereby freeing a significant amount of space inside the intermediate corrector wheel. In one advantageous embodiment, the intermediate corrector wheel surrounds all of the counter arbours, and moves the lever-corrector wheel set unit to 9 o'clock.

### BRIEF DESCRIPTION OF THE DRAWINGS

Other features and advantages of the present invention will appear more clearly from the following detailed description of an example embodiment of a display mechanism correction device according to the invention. This example is given purely by way of non-limiting illustration, with reference to the annexed drawing, in which:

FIG. 1 is a top view of a correction device according to the invention,

FIGS. 2 to 4 are cross-sections of the device along the respective axes AA, BB and CC, and

FIGS. 5 and 6 are variants of the correction device according to the invention.

### DETAILED DESCRIPTION OF THE ILLUSTRATIVE EMBODIMENTS

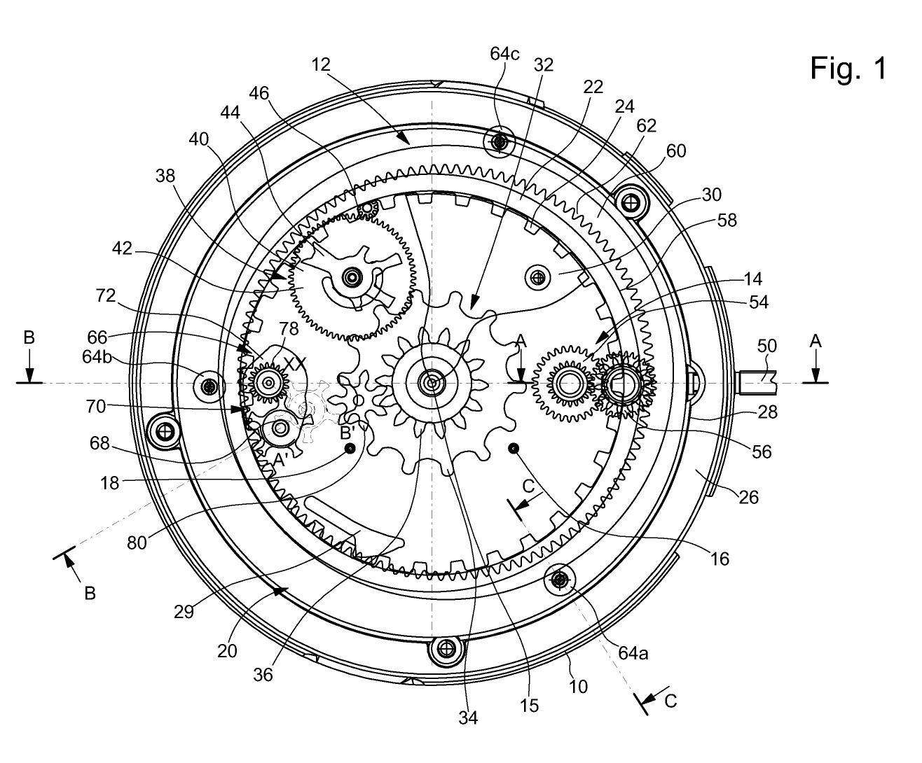

FIG. 1 shows a bottom plate 10 for a timepiece, on which there are mounted, on one side, a mechanical or electromechanical movement (not shown), fitted with a chronograph mechanism, and, on the other side, a time indication display mechanism 12 and its correction device 14. A central arbour 15 for carrying hour and minute display members (not shown) and two arbours 16 and 18, respectively located at 4 o'clock and 8 o'clock, belonging to minute and hour counters of the chronograph mechanism, pass through bottom plate 10.

The time indication display mechanism 12 is of a conventional type. It has a digital date indicator 20, formed of a ring 22 fitted with an inner toothing 24. The date indicator 20 is mounted on a calendar plate 26, which is screwed to plate 10 and has a recess 28 provided for this purpose. It is angularly positioned by a jumper spring 29 and held axially and guided in rotation by a retaining plate 30, which is secured to calendar plate 26. Display mechanism 12 also includes a day display member, such as a hand, which is not visible in FIG. 1. The day display member is mounted at the centre of plate 10 and secured to a wheel set 32 formed of a day star wheel 34 and a correction star wheel 36.

The date indicator 20 and the day display member are driven in rotation by a drive mechanism 38, which is located at 11 o'clock and includes a drive wheel set 40, formed of a wheel 42 and a finger 44, secured to each other in rotation. Finger 44 cooperates with toothing 24 and also with day star wheel 34. Wheel 42 is driven by a pinion 46 that is kinematically connected to the movement by an arbour that passes through plate 10.

The display mechanism 12 thus described is positioned behind a dial (not shown). It can display the date, through a first aperture made in the dial, and the corresponding day of the week, via the day hand, which cooperates with day indications affixed to the dial.

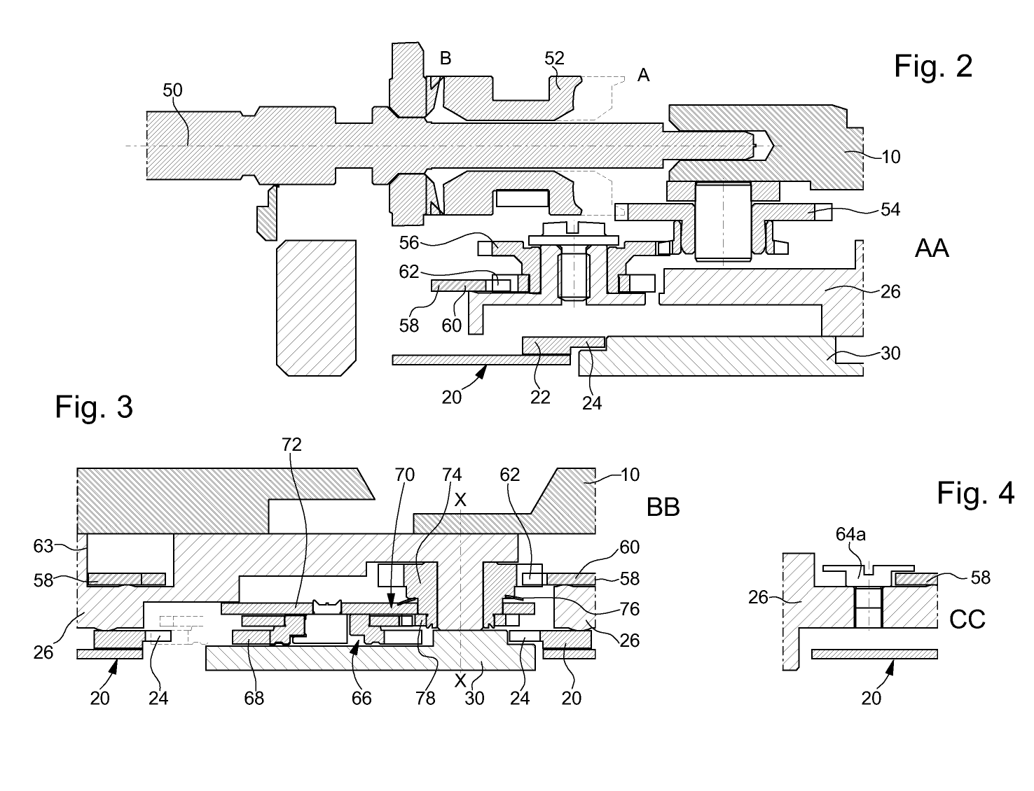

Reference will now usefully be made to FIGS. 2 to 4, which illustrate the correction device 14, seen along cross-sections AA, BB and CC. Correction device 14 of display mechanism 12 has, in a conventional manner, a winding stem 50, which is guided in rotation in plate 10. A sliding pinion 52 is secured in rotation to winding stem 50, and can move between a correcting position A and a winding position B. In correcting position A, it meshes with a first intermediate wheel 54, which is mounted to rotate freely on plate 10, and meshed with a second intermediate wheel 56, mounted to rotate freely on calendar plate 26.

The second intermediate wheel 56 is meshed with an intermediate corrector wheel 58, formed of a ring 60 with an inner toothing 62. Intermediate corrector wheel 58 is guided in rotation by its outer circumference, on calendar plate 26. A recess 63 is provided for this purpose in calendar plate 26. It is also held axially by three shouldered screws 64a, 64b, 64c, which are distributed angularly on the periphery thereof. The diameter of intermediate corrector wheel 58 is close to the diameter of date indicator 20, and it is positioned approximately centred about arbours 15, 16 and 18 of the various elements of drive mechanism 38 and correction device 14.

Intermediate corrector wheel 58 actuates a double corrector 66 mounted at 9 o'clock on calendar plate 26, and formed of a corrector wheel set 68 mounted on a lever 70. Lever 70 is pivotably mounted between first and second correcting positions, respectively A′ and B′, about a pivoting axis XX perpendicular to bottom plate 10. It includes a plate 72 mounted on a control wheel 74, whose axis of rotation merges with pivoting axis XX, meshed with intermediate corrector wheel 58. Control wheel 74 is also partially secured to plate 72 via a friction spring 76. A pinion 78 is mounted on plate 72, secured in rotation to control wheel 74, meshed with corrector wheel set 68. In first correcting position A′, the corrector wheel set meshes with toothing 24 of date indicator 20, and in second correcting position B′, it meshes with an intermediate star wheel 80, which is meshed with correction star wheel 36. In a variant of this embodiment, corrector wheel set 68 is slidably mounted in an oblong hole made in calendar plate 26, in accordance with a technique well known to those skilled in the art.

It will be noted that the correction device 14 thus described has two important advantages compared to a conventional device. First of all, the ring-shaped geometry of intermediate corrector wheel 58 frees space at the centre thereof. This space is occupied, in this case, by parts belonging to drive mechanism 38, correction device 14 and by arbours 15, 16 and 18. Secondly, because it has a diameter close to that of date indicator 20, i.e. of the order of two-thirds of the diameter of bottom plate 10, intermediate corrector wheel 58 can move double corrector 66, which cannot be mounted in proximity to winding stem 50, because of the presence of minute counter arbour 16 at 4 o'clock. In the present case, double corrector 66 is moved to 9 o'clock, but it could also be at 6 o'clock or 12 o'clock, or any other place on bottom plate 10 free to receive it. Moreover, double corrector 66 is moved relative to bottom plate 10, without any useful space being lost on said plate. This arrangement of correction device 14 is advantageous for a bottom plate 10 that is pierced with several arbours, practically whatever the position of the arbours. It will be seen below that other arrangements of correction device 14 may be envisaged for particular arbour positions.

The operation of correction device 14 is as follows. When winding stem 50 is actuated clockwise, with sliding pinion 52 in correction position A, first intermediate wheel 54 is driven anti-clockwise, and it thus drives second intermediate wheel 56 clockwise. Wheel 56 meshes with intermediate corrector wheel 58, which is rotating clockwise, and in turn drives control wheel 74 of lever 70 clockwise. Control wheel 74 pivots plate 72 under the effect of friction wheel 76, until intermediate corrector wheel set 68 meshes with date indicator 20. Control wheel 74 is then uncoupled from plate 72, and actuates corrector wheel set 68 via pinion 78. Corrector wheel set 68 corrects date indicator 20 by rotating it anti-clockwise. When winding stem 50 is actuated anti-clockwise, with the sliding pinion in correction position A, the set of intermediate wheels 54, 56, 58 rotate in the opposite direction to the preceding direction, and lever 70 pivots anti-clockwise until corrector wheel set 68 meshes with intermediate star wheel 80. The latter drives correction star wheel 36 clockwise, thus allowing correction of the day display member.

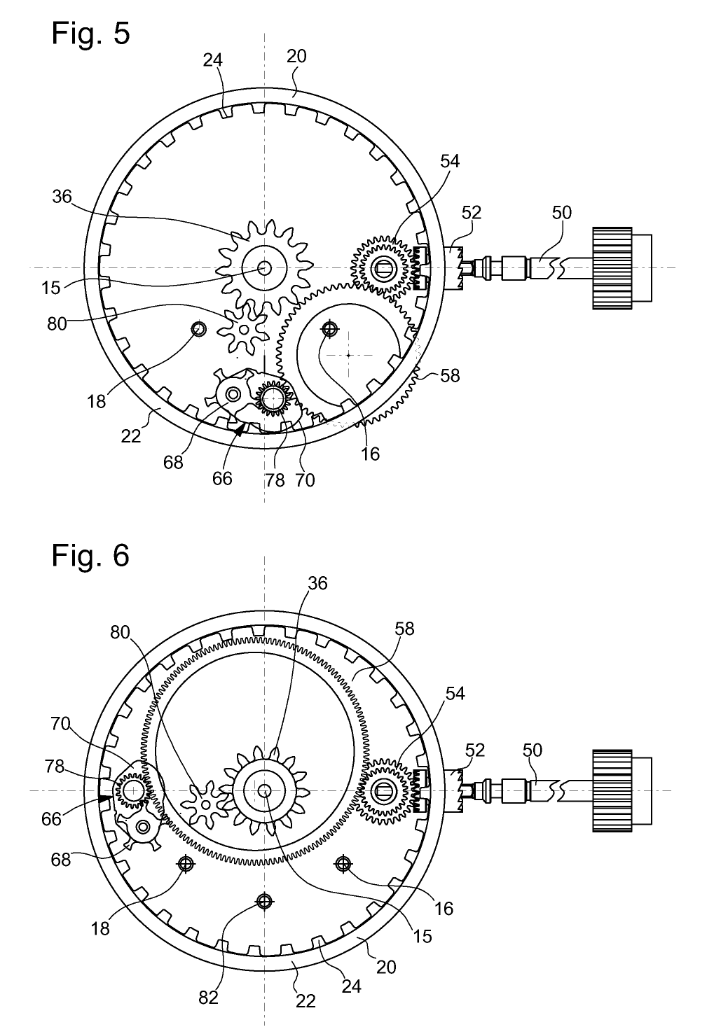

We will now refer to FIGS. 5 and 6, which illustrate variants of correction device 14 according to the invention.

The correction device 14 illustrated in FIG. 5 differs from the device illustrated in FIGS. 1 to 4, in that the diameter of intermediate corrector wheel 58 is smaller than the radius of date indicator 20 and in that it is off-centre relative to bottom plate 10, so as to occupy essentially the quarter located between 3 o'clock and 6 o'clock. The space freed at the centre of wheel 58 is essentially occupied by the minute counter arbour 16. It will be noted that arbour 15 at the centre of bottom plate 10 is excluded from this space, unlike the preceding embodiment. Double corrector 66 is located at 6 o'clock, i.e. between minute counter arbour 16 and hour counter arbour 18. Moreover, toothing 24 of intermediate corrector wheel 58 is located on its outer, not inner circumference and it is the inner circumference that guides wheel 58 in rotation. This arrangement is suitable for a bottom plate 10 that is pierced with a central arbour 15, and two off-centre arbours 16 and 18, respectively at 4 o'clock and 8 o'clock.

Finally, the correction device 14 illustrated in FIG. 6 differs from the preceding devices in that the diameter of intermediate corrector wheel 58 is smaller than the diameter of date indicator 20, but greater than its radius. Intermediate corrector wheel 58 is also off-centre relative to bottom plate 10, so as to occupy essentially the half comprised between 9 o'clock and 3 o'clock. The central arbour 15 is included in the space freed at the centre thereof. As in the preceding example, toothing 24 is an outer and not an inner toothing. The arrangement thus described is suitable for a plate that is pierced with four arbours 15, 16, 18, 82 located respectively at the centre, at 4 o'clock, 8 o'clock and 6 o'clock.

Other corrector device arrangements may be devised to suit requirements. All of these arrangements have in common a ring-shaped intermediate corrector wheel, fitted with an inner or outer toothing that is guided in rotation by one of its circumferences.

Of course, the corrector device according to the invention is not limited to the embodiments that have just been described and various simple alterations and variants could be envisaged by those skilled in the art, without departing from the scope of the invention as defined by the annexed claims.

It will be noted, in particular, that in the preceding description, intermediate corrector wheel 58 is guided in rotation by its outer or inner circumference. In a variant, intermediate corrector wheel 58 could be, for example, formed of a ring 60 fitted with a circular rib, engaged in a groove made in calendar plate 26.

It will also be noted that correction device 14 does not include a second intermediate wheel 56 in the variants illustrated in FIGS. 5 and 6. It will be clear, likewise, that the first intermediate wheel 54 is not indispensable to correction device 14, and that intermediate corrector wheel 58 can be meshed directly with sliding pinion 52.

1-11. (canceled)

12. A device for correcting a time indication, supplied by a display mechanism for a timepiece, of the type including a first display member formed of a ring that includes:
a winding stem arranged to occupy at least one time indication correcting position,
a pinion that is mounted on the winding stem and secured thereto in rotation,
an intermediate corrector wheel kinematically connected to said pinion when the stem is occupying said correcting position, and
a corrector wheel set that cooperates with said display member and is actuated by said intermediate corrector wheel,
wherein said intermediate corrector wheel is formed of a ring with an inner circumference and an outer circumference, at least one of which is fitted with a toothing, which is meshed, at least indirectly, with said corrector wheel set, and wherein said ring frees space at the centre thereof for housing parts,
wherein the diameter of said intermediate corrector wheel is close to that of the display member or off-centre relative to the bottom plate.

13. The correction device according to claim 12, wherein said intermediate corrector wheel is guided in rotation by one of the inner or outer circumferences thereof.

14. The correction device according to claim 12, wherein said intermediate corrector wheel is guided in rotation by a rib secured to the ring.

15. The correction device according to claim 12, wherein it is mounted on a bottom plate through which several arbours pass, and wherein said intermediate corrector wheel is mobile in rotation about at least one of said arbours.

16. The correction device according to claim 15, wherein said bottom plate is traversed by three arbours, one of which is centred relative to the bottom plate, and two others are off-centre, and wherein said intermediate corrector wheel is mobile in rotation about said three arbours.

17. The correction device according to claim 12, wherein the diameter of said intermediate corrector wheel is close to that of the display member and that the corrector wheel set is at approximately 9 o'clock on said bottom plate.

18. The correction device according to claim 15, wherein said intermediate corrector wheel set is mounted about a single off-centre arbour, and that the diameter of said intermediate corrector wheel is close to the radius of the display member.

19. The correction device according to claim 18, wherein said corrector wheel set is arranged at approximately 6 o'clock on the bottom plate.

20. The correction device according to claim 12, wherein said corrector wheel set is slidably mounted between a first position where it cooperates with said first display member and a second position where it cooperates at least indirectly with a second display member.

21. The correction device according to claim 12, wherein said corrector wheel set is mounted on a lever.

22. The correction device according to claim 12, wherein said corrector wheel set is slidably mounted in an oblong hole.
